(19) United States
(12) Patent Application Publication
(10) Pub. No.: US 2023/0049578 A1
(43) Pub. Date: Feb. 16, 2023

(54) AI VIDEO PROCESSING METHOD AND APPARATUS

(71) Applicant: INSPUR SUZHOU INTELLIGENT TECHNOLOGY CO., LTD., Suzhou, Jiangsu (CN)

(72) Inventor: Tuo LI, Suzhou, Jiangsu (CN)

(21) Appl. No.: 17/792,019

(22) PCT Filed: Aug. 26, 2020
(86) PCT No.: PCT/CN2020/111378

§ 371 Date: Jul. 11, 2022

(30) Foreign Application Priority Data
Jan. 12, 2020 (CN) 202010029033.4

(51) Int. Cl. G06F 9/50; H04N 19/127; H04N 19/12

(52) U.S. Cl. CPC G06F 9/5038; G06F 9/505; H04N 19/127; H04N 19/12

(57) ABSTRACT

The method comprises: connecting to a plurality of AI computing boards in an AI processing resource pool and a plurality of video encoding and decoding boards in a video processing resource pool by means of a unified high-speed interface; respectively allocating a specified number of AI computing boards and video encoding and decoding boards on account of resources and bandwidths required for completing a processing task to form a temporary cooperation relationship based on the processing task; in response to resource overflow or insufficiency in the AI processing resource pool or the video processing resource pool caused by a processing task change, accessing more AI computing boards or video encoding and decoding boards or stopping using redundant AI computing boards or video encoding and decoding boards; performing the processing task on account of the allocated AI computing boards or video encoding and decoding boards, and releasing the temporary cooperation relationship.

This application claims priority to Chinese Patent Application No. 202010029033.4, filed on Jan. 12, 2020 in China National Intellectual Property Administration and entitled “AI Video Processing Method and Apparatus”, which is hereby incorporated by reference in its entirety.

### FIELD

The present disclosure relates to the field of computers, and more particularly, to an AI video processing method and apparatus.

### BACKGROUND

Due to the development of big data industry, the amount of data shows explosive growth, while the traditional computing architecture cannot support the needs of large-scale parallel computing for deep learning, whereby the research community has conducted a new round of technology research and application research on artificial intelligence (AI) chips. AI chips are one of the core technologies in the AI era, and determine the infrastructure and development ecology of a platform. According to the technical architecture classification, the current mainstream AI chips are graphics processing units (GPU), fully customized chips (e.g. ASIC), semi-customized chips (e.g. FPGA), etc. In addition to general-purpose computing chips such as GPU, AI chips are of a great diversity of types according to the performance and supported algorithm applications, and the actual performances of different AI chips will also vary greatly under different application algorithms and scenarios.

In the current AI algorithm applications, video-related AI applications, including image detection, image recognition, image processing, etc., have the best commercial prospects and the most practical application algorithms Correspondingly, different types of applications require different data processing modes. For example, the video resolution required for image detection may be very low, and video data may be compressed as much as possible. For another example, in image processing, data often needs to be transmitted back. There are two-way bandwidth requirements for a data path. In different application scenarios, the emphasis on AI processing requirements is also different. For example, in automatic driving and on-line live broadcast, the requirements for real-time performance are very high. However, the requirements for the accuracy of data processing in on-line live broadcast may be relatively low, while on-line video processing often has no requirements for real-time performance Even in the same application type and the same application scenario, due to different algorithms and implementations, data processing, such as the scale of matrix computation and the frequency of cache data, may be greatly different in practice.

Video encoding and decoding is an indispensable technology in existing video processing technologies. Since there are too many video streams currently and a single video stream is too large (depending on the resolution), yuv is an original video stream format. A video having a resolution of 1920×1080, a format of yuv420, a frame rate of 50, and a frame number of 500 only has 10 seconds. The size of the video is: 1920×1080×3/2×500≈1.45 GB. It is conceivable that various existing interface bandwidths are not sufficient for transmission and processing of mass video if the video is transmitted in an original format. Video encoding and decoding is essentially the compression and decompression of video. The current mainstream H.264 encoding and decoding standard can maximally compress the data transmission to 1/150 (in the most extreme case, as the compression rate is higher, the definition and accuracy of decoded video are lower; in the above example, it is suitable to compress a video stream of 1.45 GB to about 6 MB for viewing the video with human eyes), and the utilization rate of data transmission bandwidth can be greatly improved, whereby it is possible to transmit mass video to the cloud for unified processing.

There are generally two architectures for chip-level acceleration of AI processing of video. One of the architectures is traditional. Existing AI chips and video encoding and decoding chips are placed on one or two daughter boards. By means of board-level connection, the data processing capacity corresponding to one AI chip determines the magnitude of performance output and the number of video encoding and decoding chips to be placed. The other architecture is being researched by some Internet companies recently. A video encoding and decoding module is placed into an AI chip to form a dedicated video processing AI chip. Similarly, in order to achieve the highest efficiency, the AI computing capacity and the video encoding and decoding capacity should be matched. Regardless of the two architectures, the video encoding and decoding and the AI processing are matched. Such a design is most straightforward when the applications, scenarios, and algorithms are all homogeneous or similar. However, at present, with the rapid development of AI field and the endless emergence of new applications and algorithms, a single architecture often limits the upgrade of applications and algorithms, thereby causing performance waste. It is impossible for either architecture to make customized modifications on the existing products that are already produced, whereby only redesign production or acceptance of efficiency reduction is possible.

No effective solution has been proposed at present for the problem in the prior art that the fixed allocation of the AI processing capacity and the video encoding and decoding capacity cannot efficiently adapt to different application scenario algorithms

### SUMMARY

In view of this, an object of embodiments of the present disclosure is to provide an AI video processing method and apparatus. The AI processing capacity and the video encoding and decoding capacity can be flexibly distributed and expanded on demand, thereby efficiently adapting to different application scenario algorithms

On the basis of the above object, in a first aspect of embodiments of the present disclosure, an AI video processing method is provided. The method includes: performing, by a control device, the following steps:

connecting to a plurality of AI computing boards in an AI processing resource pool and a plurality of video encoding and decoding boards in a video processing resource pool by means of a unified high-speed interface, so as to call AI processing resources and video processing resources;

in response to reception of a processing task, respectively allocating, from the AI processing resource pool and the video processing resource pool, a specified number of the AI computing boards and the video encoding and decoding boards on account of resources and bandwidths required for completing the processing task to form a temporary cooperation relationship based on the processing task;

in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and

performing the processing task on account of the allocated AI computing boards or the allocated video encoding and decoding boards, and releasing the temporary cooperation relationship in response to completion of the processing task.

In some implementations, each of the AI computing boards is provided with a first number of AI computing chips of same model, and each of the video encoding and decoding boards is provided with a second number of video encoding and decoding chips of same model. The first number and the second number are configured to be determined on account of bandwidths of the unified high-speed interface and complexity of physical connecting lines between the AI computing boards and the video encoding and decoding boards.

In some implementations, video encoding and decoding supported by the video encoding and decoding chips includes at least one of MPEG, H.264, H.265, AVS, and AVS+.

In some implementations, the connecting by means of the unified high-speed interface includes: establishing, by the control device, a direct connection by means of a PCIE physical interface on a main board, and/or an indirect connection via a switchboard having a PCIE switching chip.

In some implementations, the control device includes a central processing unit (CPU) arranged on the main board, and a single chip micyoco (SCM) and/or an ARM processor arranged on the switchboard.

In a second aspect of embodiments of the present disclosure, an AI video processing apparatus is provided. The apparatus includes:

an AI processing resource pool, including a plurality of AI computing boards for performing AI processing;

a video processing resource pool, including a plurality of video encoding and decoding boards for performing video processing;

a control device, connected to the plurality of AI computing boards and the plurality of video encoding and decoding boards by means of a unified high-speed interface, and including a processor and a memory, wherein the memory stores computer instructions executable on the processor, and the instructions, when executed by the processor, implement following steps:

in response to reception of a processing task, respectively allocating, from the AI processing resource pool and the video processing resource pool, a specified number of the AI computing boards and the video encoding and decoding boards on account of resources and bandwidths required for completing the processing task to form a temporary cooperation relationship based on the processing task;

in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and

calling the allocated AI computing boards or the allocated video encoding and decoding boards as AI processing resources and video processing resources for performing the processing task, and releasing the temporary cooperation relationship in response to completion of the processing task.

In some implementations, each of the AI computing boards is provided with a first number of AI computing chips of same model, and each of the video encoding and decoding boards is provided with a second number of video encoding and decoding chips of same model. The first number and the second number are configured to be determined on account of bandwidths of the unified high-speed interface and complexity of physical connecting lines between the AI computing boards and the video encoding and decoding boards.

In some implementations, video encoding and decoding supported by the video encoding and decoding chips includes at least one of MPEG, H.264, H.265, AVS, and AVS+.

In some implementations, the control device is directly connected to the plurality of AI computing boards and the plurality of video encoding and decoding boards by means of a PCIE physical interface on a main board. And/or the apparatus further includes a switchboard having a PCIE switching chip. The control device is indirectly connected to the plurality of AI computing boards and the plurality of video encoding and decoding boards via the switchboard.

In some implementations, the control device includes a CPU arranged on the main board, and a SCM and/or an ARM processor arranged on the switchboard.

The present disclosure has the following beneficial technical effects. In the AI video processing method and apparatus provided by the embodiments of the present disclosure, the technical solution includes: connecting to a plurality of AI computing boards in an AI processing resource pool and a plurality of video encoding and decoding boards in a video processing resource pool by means of a unified high-speed interface, so as to call AI processing resources and video processing resources; in response to reception of a processing task, respectively allocating, from the AI processing resource pool and the video processing resource pool, a specified number of AI computing boards and video encoding and decoding boards on account of resources and bandwidths required for completing the processing task to form a temporary cooperation relationship based on the processing task; in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and performing the processing task on account of the allocated AI computing boards or the allocated video encoding and decoding boards, and releasing the temporary cooperation relationship in response to completion of the processing task. The AI processing capacity and the video encoding and decoding capacity can be flexibly distributed and expanded on demand, thereby efficiently adapting to different application scenario algorithms

### BRIEF DESCRIPTION OF THE DRAWINGS

In order to describe the technical solution in the embodiments of the present disclosure or the prior art more clearly, drawings required to be used in the description of the embodiments or the prior art will be briefly introduced below. Apparently, the drawings in the description below are only some embodiments of the present disclosure. Those ordinarily skilled in the art also can obtain other drawings according to the provided drawings without creative work.

FIG. 1 is a flowchart of an AI video processing method according to the present disclosure.

FIG. 2 is a schematic structural diagram of a direct connection form of an AI video processing apparatus according to the present disclosure.

FIG. 3 is a schematic structural diagram of an indirect connection form of an AI video processing apparatus according to the present disclosure.

### DETAILED DESCRIPTION

In order to make the objects, technical solutions and advantages of the present disclosure clearer, embodiments of the present disclosure will be further described in detail below with reference to specific embodiments and the accompanying drawings.

It should be noted that all the expressions using “first” and “second” in the embodiments of the present disclosure are intended to distinguish two different entities with the same name or different parameters. It can be seen that “first” and “second” are merely for the convenience of expressions and should not be construed as limiting the embodiments of the present disclosure, and the subsequent embodiments will not make illustrations thereto one by one.

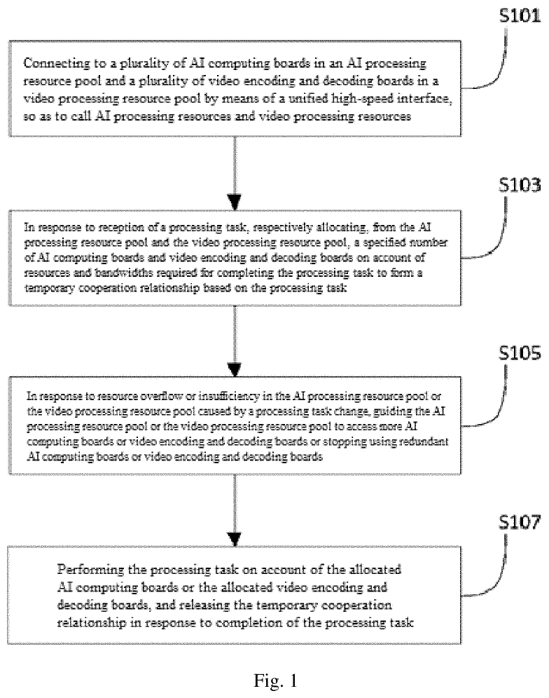

On the basis of the above object, in a first aspect of embodiments of the present disclosure, one embodiment of an AI video processing method capable of efficiently adapting to different application scenario algorithms is provided. FIG. 1 shows a flowchart of an AI video processing method according to the present disclosure.

The AI video processing method, as shown in FIG. 1, includes: performing, by a control device, the following steps:

Step S101: connecting to a plurality of AI computing boards in an AI processing resource pool and a plurality of video encoding and decoding boards in a video processing resource pool by means of a unified high-speed interface, so as to call AI processing resources and video processing resources.

Step S103: in response to reception of a processing task, respectively allocating, from the AI processing resource pool and the video processing resource pool, a specified number of AI computing boards and video encoding and decoding boards on the basis of resources and bandwidths required for completing the processing task to form a temporary cooperation relationship based on the processing task.

Step S105: in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards.

Step S107: performing the processing task on the basis of the allocated AI computing boards or the allocated video encoding and decoding boards, and releasing the temporary cooperation relationship in response to completion of the processing task.

According to the requirements of general AI video processing acceleration, the present disclosure provides a general architecture and system form in the level of a board consisting of AI chips and video decoding chips. On the premise of completing an AI video processing acceleration function, the flexible expansibility of the AI processing capacity and the video encoding and decoding capacity is maintained by means of resource pooling, thereby realizing the use and upgrading under different application scenarios and algorithms.

It will be appreciated by those ordinarily skilled in the art that implementing all or part of the processes in the above embodiment methods may be completed by a computer program that instructs associated hardware. The program may be stored in a computer-readable storage medium. When executed, the program may include processes of the above method embodiments. The storage medium may be a magnetic disk, an optical disk, a read-only memory (ROM), or a random access memory (RAM), etc. The embodiments of the computer program may achieve the same or similar effects as any of the previously described method embodiments corresponding thereto.

In some implementations, each of the AI computing boards is provided with a first number of AI computing chips of the same model, and each of the video encoding and decoding boards is provided with a second number of video encoding and decoding chips of the same model. The first number and the second number are configured to be determined on the basis of bandwidths of the unified high-speed interface and complexity of physical connecting lines between the AI computing boards and the video encoding and decoding boards.

In some implementations, video encoding and decoding supported by the video encoding and decoding chips includes at least one of MPEG, H.264, H.265, AVS, and AVS+.

In some implementations, the connecting by means of the unified high-speed interface includes: establishing, by the control device, a direct connection by means of a PCIE physical interface on a main board, and/or an indirect connection via a switchboard having a PCIE switching chip.

In some implementations, the control device includes a CPU arranged on the main board, and a SCM and/or an ARM processor arranged on the switchboard.

The method disclosed according to the embodiments of the present disclosure may also be implemented as a computer program executed by a CPU. The computer program may be stored in a computer-readable storage medium. When the computer program is executed by the CPU, the above functions defined in the method disclosed according to the embodiments of the present disclosure are performed. The above method steps and system units may also be implemented using a controller and a computer-readable storage medium for storing a computer program for causing the controller to perform the functions of the above steps or units.

Specific implementations of the present disclosure are further illustrated below according to specific embodiments.

Firstly, for selected AI chips and video encoding and decoding chips, a uniform high-speed interface is required. In the present disclosure, considering the compatibility, the current most mainstream PCIE3.0 interface is selected. Except for low-power chips applied on a device side, most chips in the current market support a PCIE interface. Moreover, the PCIE interface has the characteristic of forward compatibility, and even if PCIE4.0 becomes the mainstream interface on the market, existing chips can be compatible for use. If the chip is not compatible with PCIE3.0, an interface conversion module may be added in the board-level design.

In order to maximally maintain the generality, video encoding and decoding chips should support as many video standards as possible, including MPEG, H.264, H.265, AVS, AVS+, etc. Some of the products in the prior art do not support certain standards, and video standards beyond the primary application scenarios are abandoned only for power consumption and area considerations. However, the present disclosure is less sensitive to the power consumption area of a single chip.

The AI chips and the video encoding and decoding chips are separately placed on different daughter boards, and the board-level design is performed independently. On the one hand, the number of chips placed on a single board may be evaluated according to the board-level power consumption and the complexity of a physical connecting line. On the other hand, the amount of data transmission between the AI chips and the video encoding and decoding chips needs to be considered. If too many chips are placed, the interface bandwidth may become the bottleneck of overall performance In the present disclosure, the daughter board is connected to a host side through PCIE3.0/4.0, and two or four chips are generally placed, which specification is half of the mainstream PCIE cards in height and length. Compared with the board-level design of heterogeneous multi-core chips and heterogeneous multi-chips, the scheme of only placing the chips of the same type on the same daughter board is more prone to layout and more stable design.

AI chip daughter cards and video encoding and decoding daughter cards do not have a one-to-one corresponding relationship, but respectively construct a resource pool. That is to say, there may be a plurality of daughter cards, and if the number of daughter cards is small, a PCIE interface of a main board may be directly used for connection. If the number is large, a switch card with a PCIE switching chip needs to be added for connection.

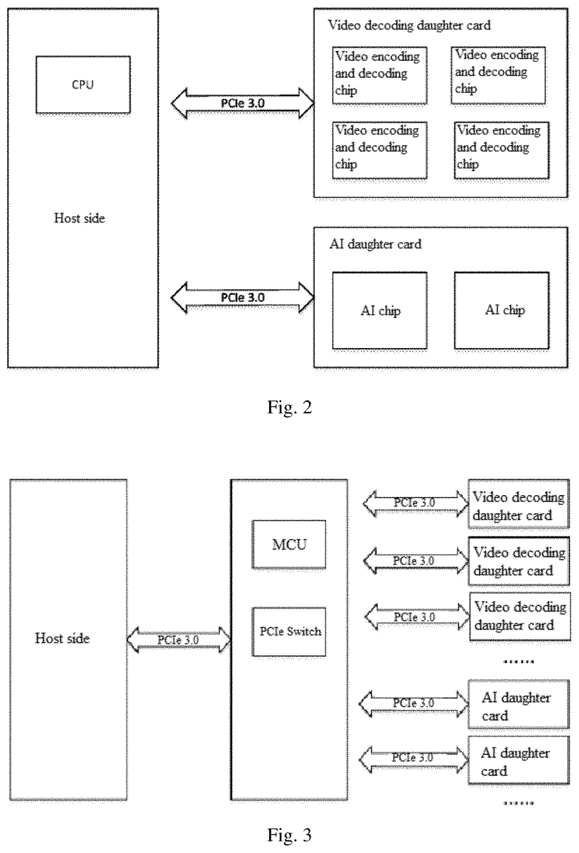

A controller is required for data transmission between the AI processing resource pool and the video encoding and decoding resource pool. In a system with small resource pools, it may be directly controlled by a CPU, the two resource pools communicate with the CPU in an interrupted manner, and the CPU sends a control signal to complete transmission according to rules. In a system with large resource pools, in order to ensure the efficiency and reduce the occupation of CPU time, a micro control unit (which may be an embedded SCM or an ARM processor) may be added to a switchboard of the PCIE switching chip for managing the data transmission of the resource pools. The two cases are shown in FIGS. 2 and 3, respectively.

There is no longer a fixed corresponding relationship between a single AI chip and one or more video encoding and decoding chips, but an interaction between the two resource pools. Therefore, for the matching of processing capacities, it is only necessary to consider the processing capacity of an overall resource pool and the limitation of data transmission bandwidth (if there are too many daughter cards connected to a single switchboard and the communication between the daughter cards is too frequent, data congestion may be caused; in this case, a more complex bus structure needs to be adopted, but it is generally impossible to place such a large-scale resource pool on a single server for the design of the overall system). When the switching of application scenarios and algorithms results in transformation of a proportional relationship between processing capacity requirements of resource pool, this problem can be solved by removing or adding daughter cards.

It can be seen from the above embodiments that, in the AI video processing method provided by the embodiments of the present disclosure, the technical solution includes: connecting to a plurality of AI computing boards in an AI processing resource pool and a plurality of video encoding and decoding boards in a video processing resource pool by means of a unified high-speed interface, so as to call AI processing resources and video processing resources; in response to reception of a processing task, respectively allocating, from the AI processing resource pool and the video processing resource pool, a specified number of AI computing boards and video encoding and decoding boards on the basis of resources and bandwidths required for completing the processing task to form a temporary cooperation relationship based on the processing task; in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and performing the processing task on the basis of the allocated AI computing boards or the allocated video encoding and decoding boards, and releasing the temporary cooperation relationship in response to completion of the processing task. The AI processing capacity and the video encoding and decoding capacity can be flexibly distributed and expanded on demand, thereby efficiently adapting to different application scenario algorithms

It should be particularly noted that the various steps in the various embodiments of the above AI video processing method may be crossed with each other, substituted, added, or deleted. Therefore, these reasonable permutations, combinations and transformations to the AI video processing method should also fall within the protection scope of the present disclosure and should not limit the protection scope of the present disclosure to the embodiments.

On the basis of the above object, in a second aspect of embodiments of the present disclosure, one embodiment of an AI video processing apparatus capable of quickly checking for efficient non-default options in BIOS is provided. The AI video processing apparatus includes:

an AI processing resource pool, including a plurality of AI computing boards for performing AI processing;

a video processing resource pool, including a plurality of video encoding and decoding boards for performing video processing; and

a control device, connected to the plurality of AI computing boards and the plurality of video encoding and decoding boards by means of a unified high-speed interface, and including a processor and a memory, wherein the memory stores computer instructions executable on the processor, and the instructions, when executed by the processor, implement the following steps:

in response to reception of a processing task, respectively allocating, from the AI processing resource pool and the video processing resource pool, a specified number of AI computing boards and video encoding and decoding boards on the basis of resources and bandwidths required for completing the processing task to form a temporary cooperation relationship based on the processing task;

in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and

calling the allocated AI computing boards or the allocated video encoding and decoding boards as AI processing resources and video processing resources for performing the processing task, and releasing the temporary cooperation relationship in response to completion of the processing task.

In some implementations, each of the AI computing boards is provided with a first number of AI computing chips of the same model, and each of the video encoding and decoding boards is provided with a second number of video encoding and decoding chips of the same model. The first number and the second number are determined on the basis of bandwidths of the unified high-speed interface and complexity of physical connecting lines between the AI computing boards and the video encoding and decoding boards.

In some implementations, video encoding and decoding supported by the video encoding and decoding chips includes at least one of MPEG, H.264, H.265, AVS, and AVS+.

In some implementations, the control device is directly connected to the plurality of AI computing boards and the plurality of video encoding and decoding boards by means of a PCIE physical interface on a main board. And/or the apparatus further includes a switchboard having a PCIE switching chip. The control device is indirectly connected to the plurality of AI computing boards and the plurality of video encoding and decoding boards via the switchboard.

In some implementations, the control device includes a CPU arranged on the main board, and a SCM and/or an ARM processor arranged on the switchboard.

It can be seen from the above embodiments that, in the AI video processing apparatus provided by the embodiments of the present disclosure, the technical solution includes: connecting to a plurality of AI computing boards in an AI processing resource pool and a plurality of video encoding and decoding boards in a video processing resource pool by means of a unified high-speed interface, so as to call AI processing resources and video processing resources; in response to reception of a processing task, respectively allocating, from the AI processing resource pool and the video processing resource pool, a specified number of AI computing boards and video encoding and decoding boards on the basis of resources and bandwidths required for completing the processing task to form a temporary cooperation relationship based on the processing task; in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and performing the processing task on the basis of the allocated AI computing boards or the allocated video encoding and decoding boards, and releasing the temporary cooperation relationship in response to completion of the processing task. The AI processing capacity and the video encoding and decoding capacity can be flexibly distributed and expanded on demand, thereby efficiently adapting to different application scenario algorithms

It should be particularly noted that in the above embodiments of the AI video processing apparatus, the embodiments of the AI video processing method are used to specifically describe the operation process of each module. It would have readily occurred to those skilled in the art to apply these modules to other embodiments of the AI video processing method. Of course, since the various steps in the embodiments of the AI video processing method may be crossed with each other, substituted, added, or deleted. Therefore, these reasonable permutations, combinations and transformations to the AI video processing apparatus should also fall within the protection scope of the present disclosure and should not limit the protection scope of the present disclosure to the embodiments.

While the above is directed to the exemplary embodiments of the present disclosure, it should be noted that various changes and modifications can be made without departing from the scope of the disclosed embodiments of the present disclosure as defined by the appended claims. It is not necessary to perform the functions, steps, and/or actions of the method claims according to the disclosed embodiments described herein in any particular order. In addition, although elements disclosed in the embodiments of the present disclosure may be described or claimed in a single form, a plurality of elements may be contemplated unless limitation to a singular element is explicitly stated.

Those ordinarily skilled in the art will appreciate that the above discussion of any embodiments is intended to be exemplary only, and is not intended to suggest that the scope of disclosure of the embodiments of the present disclosure (including the claims) is limited to these examples. Combinations of technical features in the above embodiments or in different embodiments are also possible under the idea of the embodiments of the present disclosure, and many other variations of different aspects of the embodiments of the present disclosure as described above are possible, which are not provided in detail for the sake of concision. Therefore, any omissions, modifications, equivalent replacements, improvements, etc. made within the spirit and principles of the embodiments of the present disclosure should be included within the protection scope of the embodiments of the present disclosure.

1. An artificial intelligence (AI) video processing method, comprising: performing, by a control device, following steps:
connecting to a plurality of AI computing boards in an AI processing resource pool and a plurality of video encoding and decoding boards in a video processing resource pool by means of a unified express interface, so as to call AI processing resources and video processing resources;
in response to reception of a processing task, respectively allocating, from the AI processing resource pool and the video processing resource pool, a specified number of the AI computing boards and the video encoding and decoding boards on account of resources and bandwidths required for completing the processing task to form a temporary cooperation relationship based on the processing task;
in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and
performing the processing task on account of the allocated AI computing boards or the allocated video encoding and decoding boards, and releasing the temporary cooperation relationship in response to completion of the processing task.

2. The method according to claim 1, wherein each of the AI computing boards is provided with a first number of AI computing chips of same model, and each of the video encoding and decoding boards is provided with a second number of video encoding and decoding chips of same model, wherein the first number and the second number are configured to be determined on account of bandwidths of the unified express interface and complexity of physical connecting lines between the AI computing boards and the video encoding and decoding boards.

3. The method according to claim 2, wherein video encoding and decoding supported by the video encoding and decoding chips comprises at least one of MPEG, H.264, H.265, AVS, or AVS+.

4. The method according to claim 1, wherein the connecting by means of the unified express interface comprises: establishing, by the control device, at least one of a direct connection by means of a peripheral component interconnect express (PCIE) physical interface on a main board, or an indirect connection via a switchboard having a PCIE switching chip.

5. The method according to claim 4, wherein the control device comprises a central processing unit (CPU) arranged on the main board, and at least one of a single chip micyoco (SCM) or a processor arranged on the switchboard.

6. An artificial intelligence (AI) video processing apparatus, comprising:
an AI processing resource pool, comprising a plurality of AI computing boards for performing AI processing;
a video processing resource pool, comprising a plurality of video encoding and decoding boards for performing video processing;
a control device, connected to the plurality of AI computing boards and the plurality of video encoding and decoding boards by means of a unified high-speed interface, and comprising a processor and a memory, wherein the memory stores computer instructions executable on the processor, and the computer instructions, when executed by the processor, implement following steps:
in response to reception of a processing task, respectively allocating, from the AI processing resource pool and the video processing resource pool, a specified number of the AI computing boards and the video encoding and decoding boards on account of resources and bandwidths required for completing the processing task to form a temporary cooperation relationship based on the processing task;
in response to resource overflow or insufficiency in the AI processing resource pool or the video processing resource pool caused by a processing task change, guiding the AI processing resource pool or the video processing resource pool to access more AI computing boards or video encoding and decoding boards or stopping using redundant AI computing boards or video encoding and decoding boards; and
calling the allocated AI computing boards or the allocated video encoding and decoding boards as AI processing resources and video processing resources for performing the processing task, and releasing the temporary cooperation relationship in response to completion of the processing task.

7. The apparatus according to claim 6, wherein each of the AI computing boards is provided with a first number of AI computing chips of same model, and each of the video encoding and decoding boards is provided with a second number of video encoding and decoding chips of same model, wherein the first number and the second number are configured to be determined on account of bandwidths of the unified high-speed interface and complexity of physical connecting lines between the AI computing boards and the video encoding and decoding boards.

8. The apparatus according to claim 7, wherein video encoding and decoding supported by the video encoding and decoding chips comprises at least one of MPEG, H.264, H.265, AVS, or AVS+.

9. The apparatus according to claim 6, wherein at least one of the control device is directly connected to the plurality of AI computing boards and the plurality of video encoding and decoding boards by means of a peripheral component interconnect express (PCIE) physical interface on a main board; or the apparatus further comprises a switchboard having a PCIE switching chip, wherein the control device is indirectly connected to the plurality of AI computing boards and the plurality of video encoding and decoding boards via the switchboard.

10. The apparatus according to claim 9, wherein the control device comprises a central processing unit (CPU) arranged on the main board, and at least one of a single chip micyoco (SCM) or a processor arranged on the switchboard.
